(19) United States
(12) Patent Application Publication
(10) Pub. No.: US 2020/0047467 A1
(43) Pub. Date: Feb. 13, 2020

(54) RESIN COMPOSITION FOR INTERLAYER, FILM MATERIAL FOR INTERLAYER, AND LAMINATED GLASS MANUFACTURING METHOD

(71) Applicant: HITACHI CHEMICAL COMPANY, LTD., Chiyoda-ku, Tokyo (JP)

(72) Inventors: Kouhei MUKAIGAITO, Chiyoda-ku, Tokyo (JP); Hiroaki TAKAHASHI, Chiyoda-ku, Tokyo (JP); Kazutoshi FURUZONO, Chiyoda-ku, Tokyo (JP); Eisaku ISHIKAWA, Chiyoda-ku, Tokyo (JP)

(73) Assignee: HITACHI CHEMICAL COMPANY, LTD., Chiyoda-ku, Tokyo (JP)

(21) Appl. No.: 16/344,410

(22) PCT Filed: Oct. 31, 2016
(86) PCT No.: PCT/JP2016/082323

§ 371 Date: Apr. 24, 2019

(51) Int. Cl. B32B 17/10

(52) U.S. Cl. CPC B32B 17/10743; B32B 17/10871; B32B 17/10798; B32B 2250/03; B32B 2250/40; B32B 2605/006; B32B 2355/00; B32B 2383/00; B32B 2307/412; B32B 2419/00; B32B 2255/26

(57) ABSTRACT

The present invention relates to a resin composition for an interlayer, comprising a copolymer of a monomer mixture containing a (meth)acryloyl compound and a siloxane compound having an ethylenically unsaturated group wherein an ethylenically unsaturated group equivalent is 2000 to 20000 g/mol.

### TECHNICAL FIELD

The present invention relates to a resin composition for an interlayer, a film material for an interlayer, and a method of manufacturing a laminated glass.

### BACKGROUND ART

Currently, laminated glass has been widely used as glass for windows of vehicles such as automobiles, sunroofs, interior panels because if the glass receives an external impact and is broken, broken pieces of the glass barely scatter, which is safe. The laminated glass is also used in windows of trains, airplanes, construction machines, construction products, and the like.

One example of the laminated glass includes a laminated glass obtained by interposing an interlayer for laminated glass consisting of a polyvinyl acetal resin such as a poly(vinyl butyral) resin plasticized by a plasticizer, between at least one pair of glass plates, and integrating these components (for example, see Patent Literatures 1 to 3).

### CITATION LIST

### Patent Literature

Patent Literature 1: JP S62-100463 A
Patent Literature 2: JP 2005-206445 A
Patent Literature 3: WO 2012/091117 A1

### SUMMARY OF INVENTION

### Technical Problem

Although much of the conventional laminated glass has crack resistance substantially equal to that of the glass having an identical thickness, a laminated glass which more barely breaks against the impact applied from the outside and has higher crack resistance has been demanded.

Moreover, for a reduction in weight of the laminated glass, use of a transparent plastic substrate has been examined instead of the glass plate. However, in the case where a glass plate and a transparent plastic substrate are integrated or transparent plastic substrates are integrated with a conventional interlayer interposed therebetween, air bubbles may be generated between the transparent plastic substrate and the interlayer under a high temperature or high temperature/high humidity condition.

Accordingly, an object of the present invention is to provide a resin composition for an interlayer, a film material for an interlayer, and a method of manufacturing a laminated glass which can prepare a laminated glass having high crack resistance and can form an interlayer having high anti-foaming properties in the case where a transparent plastic substrate is used.

### Solution to Problem

The present invention provides a resin composition for an interlayer, comprising a copolymer of a monomer mixture containing a (meth)acryloyl compound and a siloxane compound having an ethylenically unsaturated group wherein an ethylenically unsaturated group equivalent is 2000 to 20000 g/mol.

The (meth)acryloyl compound may contain an alkyl (meth)acrylate and a (meth)acrylate having a hydroxyl group. Moreover, the monomer mixture may contain 50 to 90 parts by mass of the alkyl (meth)acrylate, 5 to 30 parts by mass of the (meth)acrylate having a hydroxyl group, and 5 to 20 parts by mass of the siloxane compound. Furthermore, the resin composition according to the present invention may further comprise a thermal crosslinking agent.

Moreover, the present invention provides a film material for an interlayer, comprising a substrate and a resin layer disposed on the substrate, wherein the resin layer is a layer formed from the resin composition for an interlayer. The haze of the resin layer may be 5% or less.

Furthermore, the present invention provides a method of manufacturing a laminated glass including two adherents facing each other and an interlayer sandwiched between the two adherents, the method comprising: a step of bonding the two adherents with the resin layer included in the film material for an interlayer being interposed therebetween, to obtain a laminate; and a step of heating and pressurizing the laminate under a condition of 30 to 150° C. and 0.3 to 1.5 MPa, wherein at least one of the two adherents is a glass plate. One of the two adherents may be a glass plate and the other may be a transparent plastic substrate.

### Advantageous Effects of Invention

According to the present invention, a resin composition for an interlayer, a film material for an interlayer, and a method of manufacturing a laminated glass which can prepare a laminated glass having high crack resistance and can form an interlayer having high anti-foaming properties when a transparent plastic substrate is used can be provided.

### BRIEF DESCRIPTION OF DRAWINGS

FIG. 1 is a schematic sectional view illustrating one embodiment of a film material for an interlayer.

FIG. 2 is a schematic sectional view illustrating one embodiment of a laminated glass.

### DESCRIPTION OF EMBODIMENTS

Although a suitable embodiment of the present invention will be described with reference to the drawings in some cases, the present invention will not be limited to the following embodiment.

In this specification, “(meth)acrylate” means at least one of “acrylate” and its corresponding “methacrylate”. The same applies to the similar expressions such as (meth)acryloyl.

<Resin Composition for Interlayer>

The resin composition for an interlayer according to the present embodiment (hereinafter, simply referred to as “resin composition” in some cases) comprises a copolymer of a monomer mixture containing a (meth)acryloyl compound and a siloxane compound having an ethylenically unsaturated group wherein an ethylenically unsaturated group equivalent is 2000 to 20000 g/mol.

The resin composition according to the present embodiment can improve the adhesion to the surface of the adherent such as glass by containing a specific copolymer in the resin composition according to the present embodiment, and can demonstrate high crack resistance of a laminated glass by improving the toughness of the laminate to be prepared. Moreover, the resin composition can have high cohesiveness to form an interlayer having high anti-foaming properties.

(Copolymer)

The copolymer according to the present embodiment includes a structural unit based on a compound having a (meth)acryloyl group (but not having silicon as a constitutional atom), and a structural unit based on a siloxane compound having an ethylenically unsaturated group wherein an ethylenically unsaturated group equivalent is 2000 to 20000 g/mol.

Examples of a compound having one (meth)acryloyl group include (meth)acrylic acid, (meth)acrylamide, (meth)acrylamide derivatives, alkyl (meth)acrylate, (meth)acrylate having an alkylene glycol chain, (meth)acrylate having a hydroxyl group, (meth)acrylate having an aromatic ring, (meth)acrylate having an alicyclic group, (meth)acryloylmorpholine, tetrahydrofurfuryl (meth)acrylate, and (meth)acrylate having an isocyanate group.

Examples of alkyl (meth)acrylate include alkyl (meth)acrylates having an alkyl group having 1 to 18 carbon atoms such as methyl (meth)acrylate, ethyl (meth)acrylate, n-butyl (meth)acrylate, isobutyl (meth)acrylate, tert-butyl (meth)acrylate, n-pentyl (meth)acrylate, n-hexyl (meth)acrylate, n-octyl (meth)acrylate, isooctyl (meth)acrylate, 2-ethylhexyl (meth)acrylate, isodecyl (meth)acrylate, dodecyl (meth)acrylate, and stearyl (meth)acrylate. Among these, as the alkyl (meth)acrylate, n-butyl (meth)acrylate, isooctyl (meth)acrylate, 2-ethylhexyl (meth)acrylate, and n-octyl (meth)acrylate are preferred, and 2-ethylhexyl (meth)acrylate is more preferred. Moreover, alkyl acrylate is preferred to alkyl methacrylate. These alkyl (meth)acrylates may be used singly or in combinations of two or more thereof.

Examples of the (meth)acrylate having a hydroxyl group include 2-hydroxyethyl (meth)acrylate, 1-hydroxyethyl (meth)acrylate, 2-hydroxypropyl (meth)acrylate, 3-hydroxypropyl (meth)acrylate, 1-hydroxypropyl (meth)acrylate, 4-hydroxybutyl (meth)acrylate, 3-hydroxybutyl (meth)acrylate, 2-hydroxybutyl (meth)acrylate, and 1-hydroxybutyl (meth)acrylate.

Examples of the (meth)acrylate having an alkylene glycol chain include polyethylene glycol mono(meth)acrylates such as diethylene glycol mono(meth)acrylate, triethylene glycol mono(meth)acrylate, tetraethylene glycol mono(meth)acrylate, and hexaethylene glycol mono(meth)acrylate; polypropylene glycol mono(meth)acrylates such as dipropylene glycol mono(meth)acrylate, tripropylene glycol mono(meth)acrylate, and octapropylene glycol mono(meth)acrylate; polybutylene glycol mono(meth)acrylates such as dibutylene glycol mono(meth)acrylate, and tributylene glycol mono(meth)acrylate; and alkoxypolyalkylene glycol (meth)acrylates such as methoxytriethylene glycol (meth)acrylate, methoxytetraethylene glycol (meth)acrylate, methoxyhexaethylene glycol (meth)acrylate, methoxyoctaethylene glycol (meth)acrylate, methoxynonaethylene glycol (meth)acrylate, methoxypolyethylene glycol (meth)acrylate, methoxyheptapropylene glycol (meth)acrylate, ethoxytetraethylene glycol (meth)acrylate, butoxyethylene glycol (meth)acrylate, and butoxydiethylene glycol (meth)acrylate. Moreover, these alkylene glycol chain-containing (meth)acrylates may be used singly or in combinations of two or more thereof.

Examples of the (meth)acrylate having an aromatic ring include benzyl (meth)acrylate and phenoxyethyl (meth)acrylate. Examples of the (meth)acrylate having an alicyclic group include cyclohexyl (meth)acrylate, isobornyl (meth)acrylate, and dicyclopentanyl (meth)acrylate. Examples of the (meth)acrylamide derivatives include N,N-dimethylaminoethyl (meth)acrylate, N,N-dimethylaminopropyl(meth)acrylamide, N,N-dimethyl(meth)acrylamide, N-isopropyl (meth)acrylamide, N,N-diethyl(meth)acrylamide, and N-hydroxyethyl(meth)acrylamide. Examples of the (meth)acrylate having an isocyanate group include 2-(2-methacryloyloxyethyloxy)ethyl isocyanate and 2-(meth)acryloyloxyethyl isocyanate.

It is preferred that the copolymer according to the present embodiment include a structural unit based on alkyl (meth)acrylate. The copolymerization proportion of alkyl (meth)acrylate is preferably 50 to 90% by mass, more preferably 50 to 85% by mass relative to the total mass of the copolymer. If the copolymerization proportion of alkyl (meth)acrylate is within such a range, the adhesion between the resin layer and the adherent can be improved. Such a copolymer can be obtained by copolymerizing a monomer mixture containing alkyl (meth)acrylate in the same proportion as the copolymerization proportion described above. Moreover, it is more preferred that the polymerization rate be controlled to be substantially close to 100% by mass.

It is preferred that the copolymer according to the present embodiment include a structural unit based on a (meth)acrylate having a hydroxyl group. The copolymerization proportion of the (meth)acrylate having a hydroxyl group is preferably 5 to 30% by mass, more preferably 10 to 30% by mass relative to the total mass of the copolymer. If the copolymerization proportion of the (meth)acrylate having a hydroxyl group is within such a range, a transparency having a haze of 5.0% or less can be demonstrated in a reliability test (heating and humidifying condition) of the laminated glass.

The haze (Haze) is a value (%) representing turbidity, and is determined from the total transmittance Tₜ of light which is emitted from a lamp and passes through a sample and the transmittance T_{d} of the scattered light which is scattered in the sample from (T_{d}/Tₜ)×100. These are specified according to JIS K 7136, and can be readily measured with a commercially available turbidity meter, such as NDH-5000 made by Nippon Denshoku Industries Co., Ltd.

It is preferred that the (meth)acryloyl compound according to the present embodiment contain alkyl (meth)acrylate and (meth)acrylate having a hydroxyl group.

The (meth)acryloyl compound may further contain a compound having a (meth)acryloyl group and a polar group such as a morpholino group, an amino group, a carboxyl group, a cyano group, a carbonyl group, a nitro group, or a group derived from alkylene glycol. By containing (meth)acrylate having a polar group, the adhesion between the resin layer and the adherent is readily improved.

The siloxane compound according to the present embodiment is not particularly limited as long as it is a compound having a group having an unsaturated group such as a (meth)acryloyl group, a styryl group, a cinnamate ester group, a vinyl group, or an allyl group wherein the ethylenically unsaturated group equivalent is within the range of 2000 to 20000. These siloxane compounds may be used singly or in combinations of two or more thereof. Examples of the siloxane compound according to the present embodiment include a compound represented by the following formula (a) or (b).

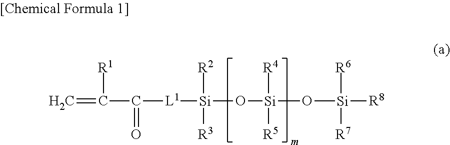

In the formula, R¹ represents a hydrogen atom or a methyl group; R², R³, R⁴, R⁵, R⁶, and R⁷ each independently represent a hydrogen atom or a methyl group; R⁸ represents a monovalent hydrocarbon group; L¹ represents a divalent hydrocarbon group or a single bond, which may have an interposed oxygen atom; m represents an integer of 1 or more. From the viewpoint of controlling the ethylenically unsaturated group equivalent within the range of 2000 to 20000 g/mol, m is preferably 10 to 300.

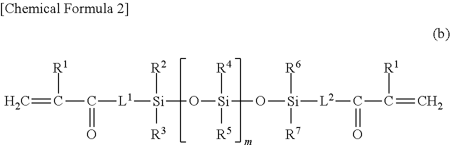

In the formula, R¹ represents a hydrogen atom or methyl group; R², R³, R⁴, R⁵, R⁶, and R⁷ each independently represent a hydrogen atom or a methyl group; L¹ and L² each independently represent a divalent hydrocarbon group or a single bond, which may have an interposed oxygen atom; and n represents an integer of 1 or more. From the viewpoint of controlling the ethylenically unsaturated group equivalent in the range of 2000 to 20000 g/mol, n is preferably 10 to 300.

Examples of the monovalent hydrocarbon group include an alkyl group or a phenyl group having 1 to 6 carbon atoms. Examples of the divalent hydrocarbon group include an alkylene group having 1 to 20 carbon atoms.

The ethylenically unsaturated group equivalent of the siloxane compound may be 3000 to 18000 g/mol, 4000 to 15000 g/mol, or 4500 to 13000 g/mol. If the ethylenically unsaturated group equivalent of the siloxane compound is within such a range, the resin composition for an interlayer has high cohesiveness and can form an interlayer having much higher anti-foaming properties.

In the copolymer according to the present embodiment, the copolymerization proportion of the monomer unit based on the siloxane compound is preferably 5 to 20% by mass, more preferably 10 to 20% by mass relative to the total mass of the copolymer. If the copolymerization proportion of the siloxane compound is within such a range, the adhesion between the resin layer and the adherent is improved, and by improving the toughness of the laminate, the crack resistance of the laminated glass is further improved.

From the viewpoint of further improving the crack resistance of the laminated glass and the transparency of the interlayer, the monomer mixture may contain 50 to 90 parts by mass of alkyl (meth)acrylate, 5 to 30 parts by mass of (meth)acrylate having a hydroxyl group, and 5 to 20 parts by mass of siloxane compound, and may contain 50 to 85 parts by mass of alkyl (meth)acrylate, 10 to 30 parts by mass of (meth)acrylate having a hydroxyl group, and 5 to 20 parts by mass of siloxane compound.

The monomer mixture may contain a compound having two or more (meth)acryloyl groups and a compound having a polymerizable group other than the (meth)acryloyl group in the range not impairing the effects achieved by the present invention. Examples of the compound having a polymerizable group other than the (meth)acryloyl group include acrylonitrile, styrene, vinyl acetate, ethylene, propylene, and divinylbenzene.

The weight average molecular weight (Mw) of the copolymer as the value converted using the calibration curve of standard polystyrene by gel permeation chromatography (GPC) is preferably 80000 to 1000000, more preferably 100000 to 900000, still more preferably 200000 to 800000. If the Mw of the copolymer is 80000 or more, the resin layer having adhesion to the adherent is readily obtained, and if the Mw is 1000000 or less, the viscosity of the resin composition is not excessively high and the processability during forming a resin layer is favorable.

The copolymer according to the present embodiment can be synthesized, for example, using a known polymerization method such as solution polymerization, emulsion polymerization, suspension polymerization, and bulk polymerization.

A compound which generates radicals by heat can be used as a polymerization initiator during synthesizing the copolymer. Examples of the polymerization initiator include organic peroxides such as benzoyl peroxide and lauroyl peroxide; and azo compounds such as 2,2′-azobisisobutyronitrile and 2,2′-azobis(2-methylbutyronitrile).

(Other Additives)

The resin composition may contain a variety of additives as needed with the copolymer.

As an additive, for example, a crosslinking agent may be used to enhance the cohesive force of the resin composition. Specific examples of the crosslinking agent include photo-crosslinking agents and thermal crosslinking agents.

Examples of the photo-crosslinking agent include alkylene diol di(meth)acrylate having an alkylene group having 1 to 20 carbon atoms; alkylene glycol di(meth)acrylates such as polyethylene glycol di(meth)acrylate and polypropylene glycol di(meth)acrylate; bisphenol di(meth)acrylates such as ethoxylated bisphenol A di(meth)acrylate, ethoxylated bisphenol F di(meth)acrylate, and bisphenol A epoxy (meth)acrylate; and urethane di(meth)acrylate having a urethane bond.

The urethane di(meth)acrylate having a urethane bond may have a polyalkylene glycol chain from the viewpoint of good miscibility with other components, and may have an alicyclic structure from the viewpoint of ensuring transparency. In the case where the miscibility between the photo-crosslinking agent and the copolymer is low, the resin film formed from the resin composition may become cloudy.

From the viewpoint of more significantly suppressing air bubbles and peel-off under a high temperature or under a high temperature and high humidity, the Mw of the photo-crosslinking agent is preferably 100000 or less, more preferably 300 to 100000, still more preferably 500 to 80000.

When the photo-crosslinking agent is used, the content is preferably 15% by mass or less, more preferably 10% by mass or less, still more preferably 7% by mass or less relative to the total mass of the copolymer. If the content is within such a range, a resin layer having sufficient adhesion can be obtained. The lower limit of the content of the photo-crosslinking agent is not particularly limited; from the viewpoint of providing good film formability, the lower limit is preferably 0.1% by mass or more, more preferably 2% by mass or more, still more preferably 3% by mass or more.

As the thermal crosslinking agent, for example, thermal crosslinking agents such as isocyanate compounds, melamine compounds, and epoxy compounds can be used. To form a network structure of a thermal crosslinking agent loosely expanded in the resin layer, polyfunctional thermal crosslinking agents such as trifunctional and tetrafunctional thermal crosslinking agents are more preferred.

From the viewpoint of the reactivity, as the thermal crosslinking agent, isocyanate compounds are preferred, and polyisocyanate compounds are more preferred. Examples of the polyisocyanate compounds include trimers of hexamethylene diisocyanate, and polyfunctional hexamethylene diisocyanate compounds which are reaction products of a triol such as trimethylolpropane, a diol or a monohydric alcohol and hexamethylene diisocyanate.

When the thermal crosslinking agent is used, the content is preferably 5% by mass or less, more preferably 2% by mass or less, still more preferably 1% by mass or less relative to the total mass of the copolymer. If the content is within such a range, a resin layer having sufficient adhesion can be obtained. The lower limit of the content of the thermal crosslinking agent is not particularly limited; from the viewpoint of providing good film formability, the content is preferably 0.01% by mass or more.

If either the copolymer or the crosslinking agent is a system curable with active energy beams, a photopolymerization initiator is needed. The photopolymerization initiator promotes a curing reaction with irradiation with active energy beams. The active energy beams indicate ultraviolet light, electron beam, α-rays, β-rays, γ-rays, and the like.

The photopolymerization initiator is not particularly limited, and known materials such as benzophenone compounds, anthraquinone compounds, benzoyl compounds, sulfonium salts, diazonium salts, and onium salts can be used.

Examples of the photopolymerization initiator include aromatic ketone compounds such as benzophenone, N,N,N′,N′-tetramethyl-4,4′-diaminobenzophenone (Michler's ketone), N,N,N′,N′-tetraethyl-4,4′-diaminobenzophenone, 4-methoxy-4′-dimethylaminobenzophenone, α-hydroxyisobutylphenone, 2-ethylanthraquinone, t-butylanthraquinone, 1,4-dimethylanthraquinone, 1-chloroanthraquinone, 2,3-dichloroanthraquinone, 3-chloro-2-methylanthraquinone, 1,2-benzoanthraquinone, 2-phenylanthraquinone, 1,4-naphthoquinone, 9,10-phenanthraquinone, thioxanthone, 2-chlorothioxanthone, 1-hydroxycyclohexyl phenyl ketone, 2,2-dimethoxy-1,2-diphenylethan-1-one, 2-hydroxy-2-methyl-1-phenylpropan-1-one, and 2,2-diethoxyacetophenone; benzoin compounds such as benzoin, methylbenzoin, and ethylbenzoin; benzoin ether compounds such as benzoin methyl ether, benzoin ethyl ether, benzoin isobutyl ether, and benzoin phenyl ether; benzyl compounds such as benzyl and benzyl dimethyl ketal; ester compounds such as β-(acridin-9-yl)(meth)acrylic acid; acridine compounds such as 9-phenylacridine, 9-pyridylacridine, and 1,7-diacridinoheptane; 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)5-phenyl imidazole dimer, 2-(2,4-dimethoxyphenyl)-4,5-diphenylimidazole dimer, and 2-(p-methylmercaptophenyl)-4,5-diphenylimidazole dimer; 2-benzyl-2-dimethylamino-1-(4-morpholinophenyl)-1-butanone; 2-methyl-1-[4-(methylthio)phenyl]-2-morpholino-1-propane; bis(2,4,6-trimethylbenzoyl)-phenylphosphine oxides; and oligo(2-hydroxy-2-methyl-1-(4-(1-methylvinyl)phenyl)propanone). These compounds may be used in combination.

Examples of the photopolymerization initiator which does not color the resin composition include α-hydroxyalkylphenone compounds such as 1-hydroxycyclohexyl phenyl ketone, 2-hydroxy-2-methyl-1-phenyl-propan-1-one, 1-[4-(2-hydroxyethoxy)-phenyl]-2-hydroxy-2-methyl-1-propan-1-one; acyl phosphine oxide compounds such as bis(2,4,6-trimethylbenzoyl)-phenylphosphine oxide, bis(2,6-dimethoxybenzoyl)-2,4,4-trimethyl-pentylphosphine oxide, 2,4,6-trimethylbenzoyl-diphenylphosphine oxide; and oligo(2-hydroxy-2-methyl-1-(4-(1-methylvinyl)phenyl)propanone).

To form a particularly thick resin layer, the photopolymerization initiator may contain an acyl phosphine oxide compound such as bis(2,4,6-trimethylbenzoyl)-phenylphosphine oxide, bis(2,6-dimethoxybenzoyl)-2,4,4-trimethyl-pentylphosphine oxide, and 2,4,6-trimethylbenzoyl-diphenylphosphine oxide.

The content of the photopolymerization initiator is preferably 0.05 to 5% by mass, more preferably 0.1 to 3% by mass, still more preferably 0.1 to 0.5% by mass relative to the total mass of the resin composition. By controlling the content to be 5% by mass or less, an interlayer having a high transmittance, a hue without yellowness, and high transparency can be obtained.

The resin composition may contain other additives than the crosslinking agent when necessary. Examples of the additives include polymerization inhibitors added to enhance the storage stability of the resin composition, such as paramethoxyphenol, antioxidants added to enhance the heat resistance of the interlayer obtained by photo-curing the resin composition, such as triphenyl phosphate, light stabilizers added to enhance the resistance of the resin composition against light such as ultraviolet light, such as HALS (Hindered Amine Light Stabilizer), and silane coupling agents added to enhance the adhesion of the resin composition to glass.

<Film Material for Interlayer>

The film material for an interlayer according to the present embodiment has a substrate, and a resin layer disposed on the substrate. The resin layer is a layer formed from the resin composition for an interlayer described above.

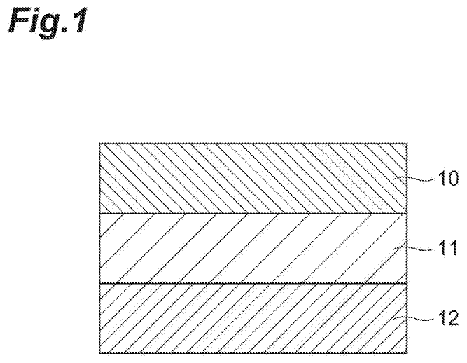

As illustrated in FIG. 1, the film material for an interlayer according to the present embodiment may include a resin layer 11, and one substrate 10 and the other substrate 12 which are laminated so as to sandwich the resin layer 11.

As the substrate 10, use of a substrate which is easier to peel than those of substrate 12 is preferred. Examples of the substrate 10 include polymer films such as those of polyethylene terephthalate, polypropylene, and polyethylene; among these, a polyethylene terephthalate film (hereinafter, also referred to as “PET film” in some cases) is preferred. The thickness of the substrate 10 is preferably 25 to 150 μm, more preferably 30 to 100 μm, still more preferably 40 to 80 μm from the viewpoint of the workability.

It is preferred that the planar shape of the substrate 10 be larger than the planar shape of the resin layer 11 and the outer edge of the substrate 10 be externally projected from the outer edge of the resin layer 11. The width of the outer edge of the substrate 10 projected from the outer edge of the resin layer 11 is preferably 2 to 20 mm, more preferably 4 to 10 mm from the viewpoint of easiness in handling, easiness in peeling, and a further reduction in adhesion of dust or the like. In the case where the planar shapes of the resin layer 11 and the substrate 10 are an approximately rectangular shape such as an approximately oblong shape, the width of the outer edge of the substrate 10 projected from the outer edge of the resin layer 11 is preferably 2 to 20 mm in at least one side, more preferably 4 to 10 mm in at least one side, still more preferably 2 to 20 mm in all sides, particularly preferably 4 to 10 mm in all sides.

It is preferred that a substrate which is more difficult peel than those of the substrate 10 be used as the substrate 12. Examples of the substrate 12 include polymer films such as those of polyethylene terephthalate, polypropylene, and polyethylene; among these, PET films are preferred. From the viewpoint of the workability, the thickness of the substrate 12 is preferably 50 to 200 μm, more preferably 60 to 150 μm, still more preferably 70 to 130 μm.

It is preferred that the planar shape of the substrate 12 be larger than the planar shape of the resin layer 11 and the outer edge of the substrate 12 be externally projected from the outer edge of the resin layer 11. The width of the outer edge of the substrate 12 projected from the outer edge of the resin layer 11 is preferably 2 to 20 mm, more preferably 4 to 10 mm from the viewpoint of easiness in handling, easiness in peeling, and a further reduction in adhesion of dust or the like. In the case where the planar shapes of the resin layer 11 and the substrate 12 are an approximately rectangular shape such as an approximately oblong shape, the width of the outer edge of the substrate 12 projected from the outer edge of the resin layer 11 is preferably 2 to 20 mm in at least one side, more preferably 4 to 10 mm in at least one side, still more preferably 2 to 20 mm in all sides, particularly preferably 4 to 10 mm in all sides.

It is preferred that the peel strength between the substrate 10 and the resin layer 11 be lower than the peel strength between the substrate 12 and the resin layer 11. Thereby, the substrate 12 is more difficult to peel from the resin layer 11 than from the substrate 10. The peel strength can be adjusted by performing a surface treatment on the substrate 12 and the substrate 10, for example. Examples of the surface treatment method include releasing treatment of a substrate with a silicone compound or a fluorine compound.

A known technique can be used as a method of forming the resin layer 11. For example, first, the resin composition according to the present embodiment is diluted with a volatile solvent such as 2-butanone, cyclohexanone, methyl ethyl ketone, ethyl acetate, or toluene to prepare a coating solution. Next, the coating solution is applied onto the substrate 12, and the solvent can be removed by drying to form a resin layer having any thickness. During the preparation of the coating solution, the components may be compounded and then diluted with a solvent, or may be preliminarily diluted with a solvent before the compounding of the components. As the coating method, for example, a known method such as flow coating, roll coating, gravure coating, wire bar coating, or lip die coating can be used.

After the resin layer 11 is formed on the substrate 12, the substrate 10 is laminated on the resin layer 11 to prepare a film material for an interlayer according to the present embodiment. The resin layer 11 is configured to be sandwiched between the substrate 10 and the substrate 12. To control the peelability of the resin layer 11 from the substrate 10 and the substrate 12, the resin composition may contain a surfactant such as a polydimethylsiloxane surfactant or a fluorine surfactant.

The thickness of the resin layer 11 is not particularly limited because the thickness is appropriately adjusted by the application and the method to be used; the thickness may be 10 to 5000 μM, 25 to 200 μm, 25 to 180 μm, or 25 to 150 μm. In the case of use in this range, an interlayer for laminated glass having higher crack resistance against an impact applied from the outside is obtained.

The light transmittance of the light beam in the visible light region (wavelength: 380 nm to 780 nm) in the resin layer 11 is preferably 80% or more, more preferably 90% or more, still more preferably 95% or more.

The haze of the resin layer 11 is preferably 5% or less, more preferably 3% or less, still more preferably 1% or less.

According to the film material for an interlayer according to the present embodiment, storage and transportation can be facilitated without damaging the resin layer 11.

The resin layer 11 can be used as an interlayer for bonding adherents; for example, glasses, glass and a transparent plastic substrate, or transparent plastic substrates can be bonded to each other. The resin layer 11 can form an interlayer having high anti-foaming properties when a transparent plastic substrate is used as at least one of the adherents.

<Laminated Glass>

The film material for an interlayer according to the present embodiment can be used in bonding of adherents such as glass and transparent plastic substrates.

The laminated glass according to the present embodiment includes two adherents facing each other, and an interlayer sandwiched between the two adherents, and at least one of the two adherents is a glass plate. In the laminated glass, one of the adherents may be a glass plate and the other may be a transparent plastic substrate.

Examples of glass include float glass, air-cooled toughened glass, chemically toughened glass, and multilayer glass. The thickness of the glass may be 0.1 to 50 mm, 0.5 to 30 mm, 1 to 20 mm, or 2 to 10 mm, for example.

Examples of the transparent plastic substrate include acrylic resin substrates, polycarbonate substrates, cycloolefin polymer substrates, and polyester substrates. The thickness of the transparent plastic substrate may be 0.1 to 10 mm, 0.5 to 5 mm, or 1 to 5 mm, for example.

The method of manufacturing a laminated glass according to the present embodiment comprises: a step of bonding adherents with a resin layer including the film material for an interlayer described above being interposed therebetween, to obtain a laminate; and a step of heating and pressurizing the laminate under the condition of 30 to 150° C. and 0.3 to 1.5 MPa.

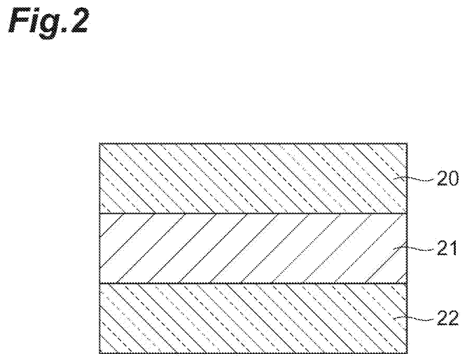

FIG. 2 is a sectional view schematically illustrating one embodiment of the laminated glass. In the laminated glass illustrating FIG. 2, a float glass 20 (first adherent), an interlayer 21, and a float glass 22 (second adherent) are disposed in this order. The laminated glass illustrated in FIG. 2 can, for example, be manufactured by the following method.

First, the substrate 10 in the film material for an interlayer is peeled from the resin layer 11 to expose the surface of the resin layer 11. Next, the surface of the resin layer 11 serving as the interlayer 21 is bonded to a first adherent float glass 20, and is pressed with a roller or the like, and then the substrate 12 is peeled from the resin layer 11 to expose its surface. Subsequently, the surface of the resin layer 11 is bonded to a second adherent float glass 22, and a heating and pressurizing treatment (autoclave treatment) is performed to prepare a laminated glass in which the float glass 20 and the float glass 21 are bonded with the interlayer 21 (resin layer 11) being interposed therebetween.

By using the resin layer 11, the adherents can be readily bonded to each other causing no wrinkles, and the step of performing a heating and pressurizing treatment can be performed at low temperature in a short time. By using the resin layer 11, the stable transparency of the laminated glass can be maintained without interlayer 21 whitened.

For the condition for the heating and pressurizing treatment, the temperature is 30 to 150° C. and the pressure is 0.3 to 1.5 MPa, from the viewpoint of removing much more involved air bubbles, the temperature may be 50 to 70° C. and the pressure may be 0.3 to 0.5 MPa. Moreover, the treatment time is preferably 5 to 60 minutes, more preferably 10 to 30 minutes.

Although float glass is used as the second adherent in the embodiment above, the second adherent may be a transparent plastic substrate.

The interlayer according to the present embodiment may be used to bond functional layers having functions, such as an anti-reflective layer for the laminated glass, a dirt resistant layer, a dye layer, and a hardcoat layer, in combination.

The anti-reflective layer may be a layer having anti-reflective properties such that the visible light reflectance is 5% or less. As the anti-reflective layer, a layer of a transparent substrate, such as a transparent plastic film, treated with a known anti-reflection method can be used.

The dirt resistant layer is used to obstruct adhesion of dirt to the surface. As the dirt resistant layer, a known layer composed of a fluorine resin or a silicone resin can be used to reduce surface tension.

The dye layer is used to enhance the color purity, and is used to reduce the light having unnecessary wavelengths which passes through the laminated glass. The dye layer can be obtained by dissolving a dye which absorbs the light having unnecessary wavelengths in a resin, and forming or laminating the dye onto a substrate film such as a polyethylene film or a polyester film.

The hardcoat layer is used to enhance the surface hardness. As the hardcoat layer, for example, a layer of an acrylic resin such as urethane acrylate or epoxy acrylate, or an epoxy resin formed or laminated onto a substrate film such as a polyethylene film can be used. Similarly to enhance the surface hardness, a hardcoat layer formed or lamented onto a transparent protective plate made of glass, acrylic resin, polycarbonate, or the like can also be used.

In the case where such a laminate is formed, the resin layer 11 can be laminated using a roll laminate, a vacuum bonding machine, or a sheet bonding machine.

By the method of manufacturing a laminated glass according to the present embodiment, a laminated glass having high crack resistance against an impact applied from the outside can be prepared. Moreover, in the case where a transparent plastic substrate is used as one of the adherents, a laminated glass in which no peel-off or air bubbles are generated between the adherent and the interlayer can be prepared by the method above.

### EXAMPLES

Hereinafter, the present invention will be described by way of Examples. The present invention will not be limited to Examples below.

The weight average molecular weights (Mw) of the copolymers prepared in Production Examples were measured according to GPC using a calibration curve with standard polystyrene and the following GPC measurement apparatus and measurement conditions.

RI detector: L-3350 (Hitachi, Ltd., product name)
eluent: THF
columns: Gelpac GL-R420+R430+R440 (Hitachi Chemical Company, Ltd., product name)
column temperature: 40° C.
flow rate: 2.0 mL/min

### Production Example 1

85.0 g of 2-ethylhexyl acrylate, 10.0 g of 2-hydroxyethyl acrylate, and 5.0 g of a single terminal methacryloyl modified polysiloxane compound (made by Shin-Etsu Chemical Co., Ltd., product name “X-22-2426”, ethylenically unsaturated group equivalent: 12000 g/mol), and 145.0 g of ethyl acetate were added into a reaction container provided with a cooling tube, a thermometer, a stirrer, a drop funnel, and a nitrogen inlet pipe, and were heated from normal temperature (25° C.) to 65° C. for 15 minutes while the reaction container was being purged with nitrogen at a flow rate of 100 mL/min. Next, while the temperature was kept at 65° C., a solution of 0.1 g of lauroyl peroxide dissolved in 5.0 g of ethyl acetate was placed, and the reaction was performed for 8 hours to obtain a solution of a copolymer A-1 (Mw: 700000) having a solid concentration of 40%.

### Production Example 2

A solution of a copolymer A-2 (Mw: 700000) having a solid concentration of 40% was obtained by the same operation as that in Production Example 1 except that 70.0 g of 2-ethylhexyl acrylate, 10.0 g of 2-hydroxyethyl acrylate, 20.0 g of a single terminal methacryloyl modified polysiloxane compound (ethylenically unsaturated group equivalent: 12000 g/mol), and 145.0 g of ethyl acetate were added to the reaction container.

### Production Example 3

A solution of a copolymer A-3 (Mw: 700000) having a solid concentration of 40% was obtained by the same operation as that in Production Example 1 except that 80.0 g of 2-ethylhexyl acrylate, 10.0 g of 2-hydroxyethyl acrylate, 10.0 g of a single terminal methacryloyl modified polysiloxane compound (Shin-Etsu Chemical Co., Ltd., product name “KF-2012”, ethylenically unsaturated group equivalent: 4600 g/mol), and 145.0 g of ethyl acetate were added to the reaction container.

### Production Example 4

A solution of a copolymer A-4 (Mw: 700000) having a solid concentration of 40% was obtained by the same operation as that in Production Example 1 except that 70.0 g of 2-ethylhexyl acrylate, 10.0 g of 2-hydroxyethyl acrylate, 10.0 g of acryloylmorpholine, 10.0 g of a single terminal methacryloyl modified polysiloxane compound (ethylenically unsaturated group equivalent: 12000 g/mol), and 145.0 g of ethyl acetate were added to the reaction container.

### Production Example 5

A solution of a copolymer A-5 (Mw: 700000) having a solid concentration of 40% was obtained by the same operation as that in Production Example 1 except that 90.0 g of 2-ethylhexyl acrylate, 10.0 g of 2-hydroxyethyl acrylate, and 145.0 g of ethyl acetate were added.

### Production Example 6

A solution of a copolymer A-6 (Mw: 700000) having a solid concentration of 40% was obtained by the same operation as that in Production Example 1 except that 80.0 g of 2-ethylhexyl acrylate, 10.0 g of 4-hydroxybutyl acrylate, 10.0 g of a single terminal methacryloyl modified polysiloxane compound (Shin-Etsu Chemical Co., Ltd., product name “X-22-174ASX” (ethylenically unsaturated group equivalent: 900 g/mol), and 145.0 g of ethyl acetate were added to the reaction container.

<Preparation of Resin Composition for Interlayer and Preparation of Film Material for Interlayer>

### Example 1

0.2 parts by mass of a polyisocyanate compound (Tosoh Corporation, product name “CORONATE HL”) as a thermal crosslinking agent was mixed relative to 100 parts by mass of the copolymer in the copolymer A-1 solution obtained Production Example 1 to prepare a coating solution of a resin composition.

Next, using a bar coater, the coating solution of the resin composition was applied onto a PET film (substrate 12) having a surface subjected to a releasing treatment and having a thickness of 75 μm such that the dry thickness was 100 μm, and was heated and dried at 100° C. for 10 minutes to form a resin layer. Subsequently, a PET film (substrate 10) subjected to a releasing treatment and having a thickness of 75 μm was disposed over the resin layer, and was attached to a hand roller of 1.0 kgf to prepare a film material for an interlayer.

### Example 2

A coating solution of the resin composition and a film material for an interlayer were obtained in the same manner as in Example 1 except that the solution of the copolymer A-2 obtained in Production Example 2 was used.

### Example 3

A coating solution of the resin composition and a film material for an interlayer were obtained in the same manner as in Example 1 except that the solution of the copolymer. A-3 obtained in Production Example 3 was used.

### Example 4

A coating solution of the resin composition and a film material for an interlayer were obtained in the same manner as in Example 1 except that the solution of the copolymer A-4 obtained in Production Example 4 was used.

### Comparative Example 1

A coating solution of the resin composition and a film material for an interlayer were obtained in the same manner as in Example 1 except that the solution of the copolymer A-5 obtained in Production Example 5 was used.

### Comparative Example 2

A coating solution of the resin composition and a film material for an interlayer were obtained in the same manner as in Example 1 except that the solution of the copolymer A-6 obtained in Production Example 6 was used.

### Comparative Example 3

100 parts by mass of a poly(vinyl butyral) resin (degree of acetalation: 68.0 mol %, proportion of the vinyl acetate component: 0.6 mol %) having a half width of the peak at 245 cm⁻¹, the peak corresponding to the hydroxyl group obtained when the infrared absorption spectrum was measured, and 38 parts by mass of triethylene glycol bis(2-ethylhexanoate) as a plasticizer were mixed, were sufficiently melt kneaded with a mixing roll, and were press molded with a press molding machine at 150° C. for 30 minutes to obtain a resin film having a thickness of 380 μm; and this was used as an interlayer for laminated glass.

<Evaluation>

The film materials for an interlayer or the resin films obtained in each Example and Comparative Example was evaluated by the following methods. The results are shown in Table 1.

1. Measurement of Haze

The film materials for an interlayer in Examples and Comparative Examples 1 and 2 were cut into a size of 50 mm×50 mm, were left for 24 hours under a condition at 85° C. and 85% RH, and were extracted; the substrate 10 was peeled to expose the surface of the resin layer, and the surface of the resin layer was bonded to a float glass having a length of 50 mm, a width of 50 mm, and a thickness of 2.7 mm, and was pressed with a roller. The substrate 12 was peeled from the resin layer to expose the surface of the resin layer, and the surface of the resin layer was bonded in vacuum to a float glass having a length of 50 mm, a width of 50 mm, and a thickness of 2.7 mm using a vacuum laminator to prepare a laminate. Subsequently, the laminate was subjected to a heating and pressurizing treatment (autoclave treatment) on a condition where the temperature was kept at 50° C. and the pressure was kept at 0.5 MPa for 30 minutes, obtaining a laminated glass. Moreover, in Comparative Example 3, the resin film was cut into a size of 50 mm×50 mm, was left for 24 hours under a condition at 85° C. and 85% RH, was extracted, was sandwiched between the float glasses, and was subjected to an autoclave treatment under the condition of a temperature of 135° C. and a pressure of 118 N/cm² MPa for 20 minutes, obtaining a laminated glass.

The haze of the obtained laminated glass was measured using a turbidity meter (made by Nippon Denshoku Industries Co., Ltd., NDH-5000).

2. Preparation of Laminated Glass

In Examples and Comparative Examples 1 and 2, the substrate 10 was peeled from the prepared film material for an interlayer to expose the surface of the resin layer, and the surface of the resin layer was bonded to a float glass having a length of 110 mm, a width of 110 mm, and a thickness of 2.7 mm, which was a first adherent, and was pressed with a roller. Next, the substrate 12 was peeled from the resin layer to expose the surface of the resin layer, and using a vacuum laminator, the surface of the resin layer was bonded in vacuum to a float glass having a length of 110 mm, a width of 110 mm, and a thickness of 2.7 mm, which was a second adherent, to prepare a laminate. Subsequently, the laminate was subjected to a heating and pressurizing treatment (autoclave treatment) on a condition where the temperature was kept at 50° C. and the pressure was kept at 0.5 MPa for 30 minutes, obtaining a laminated glass.

Moreover, in Comparative Example 3, the resin film was sandwiched between the float glasses, and was subjected to an autoclave treatment under the condition of a temperature of 135° C. and a pressure of 118 N/cm² MPa for 20 minutes, obtaining a laminated glass.

3. Impact Durability Test

A steel ball having a mass of about 1040 g and a diameter of 63.5 min was sequentially dropped from a height in an increment of 5 cm from 5 cm to 100 cm to a position within 25 mm from the central point of the prepared laminated glass of a square having a length of 110 mm and a width of 110 mm (its periphery was supported), and the height when the glass broke was recorded. Six sheets of laminated glass consisting of each interlayer were tested, and the average height was calculated; if the value was larger, the laminated glass had higher crack resistance.

5. Evaluation of Anti-Foaming Properties

The same operation was performed as that in 2. Preparation of laminated glass above except that the first adherent was replaced with a float glass having a length of 70 mm, a width of 50 mm, and a thickness of 2 mm and the second adherent was replaced with a polycarbonate plate having a length of 70 mm, a width of 50 mm, and a thickness of 2 mm, and the glass plate and the transparent plastic substrate were bonded to prepare a sample for evaluation of anti-foaming properties. Evaluation was performed by treating the sample on the following conditions, respectively, extracting the sample, and visually checking the presence/absence of peel-off and foaming. In Table 1, “A” indicates that the sample has no generation of peel-off and air bubbles in all the treatment conditions, and “B” indicates that the sample has generation of peel-off and air bubbles in any of the treatment conditions.

### (Treatment Condition)

### (1) High Temperature and High Humidity Test

The sample was left for 24 hours under a condition at 85° C. and 85% RH.

### (2) High Temperature Test

The sample was left for 24 hours under a condition at 85° C.

### (3) Heat Cycle Test

A heat cycle was repeated 20 times, in which the sample was left for 30 minutes in a −30° C. atmosphere, and then was left for 30 minutes in a 85° C. atmosphere.

TABLE 1

| | Example | | | | Comparative Example | | |
|---|---|---|---|---|---|---|---|
| | 1 | 2 | 3 | 4 | 1 | 2 | 3 |
| Copolymer A-1 | 100 | — | — | — | — | — | — |
| Copolymer A-2 | — | 100 | — | — | — | — | — |
| Copolymer A-3 | — | — | 100 | — | — | — | — |
| Copolymer A-4 | — | — | — | 100 | — | — | — |
| Copolymer A-5 | — | — | — | — | 100 | — | — |
| Copolymer A-6 | — | — | — | — | — | 100 | — |
| Poly(vinyl butyral) | — | — | — | — | — | — | 100 |
| resin | | | | | | | |
| Thermal crosslinking | 0.2 | 0.2 | 0.2 | 0.2 | 0.2 | 0.2 | — |
| agent | | | | | | | |
| Plasticizer | — | — | — | — | — | — | 38 |
| Thickness (μm) | 100 | 100 | 100 | 100 | 100 | 100 | 380 |
| Haze (%) | 0.5 | 0.5 | 0.5 | 0.5 | 0.7 | 0.5 | 0.5 |
| Height at which | 100< | 100< | 100< | 100< | 50 | 100< | 30 |
| glass broke (cm) | | | | | | | |
| Anti-foaming | A | A | A | A | B | B | B |
| properties | | | | | | | |

### REFERENCE SIGNS LIST

10, 12: substrate, 11: resin layer, 20, 22: float glass, 21: interlayer.

1. A resin composition for an interlayer, comprising a copolymer of a monomer mixture containing a (meth)acryloyl compound and a siloxane compound having an ethylenically unsaturated group wherein an ethylenically unsaturated group equivalent is 2000 to 20000 g/mol.

2. The resin composition for an interlayer according to claim 1, wherein the (meth)acryloyl compound contains an alkyl (meth)acrylate and a (meth)acrylate having a hydroxyl group.

3. The resin composition for an interlayer according to claim 2, wherein the monomer mixture contains 50 to 90 parts by mass of the alkyl (meth)acrylate, 5 to 30 parts by mass of the (meth)acrylate having a hydroxyl group, and 5 to 20 parts by mass of the siloxane compound.

4. The resin composition for an interlayer according to claim 1, further comprising a thermal crosslinking agent.

5. A film material for an interlayer, comprising a substrate and a resin layer disposed on the substrate,
wherein the resin layer is a layer formed from the resin composition for an interlayer according to claim 1.

6. The film material for an interlayer according to claim 5, wherein a haze of the resin layer is 5% or less.

7. A method of manufacturing a laminated glass including two adherents facing each other and an interlayer sandwiched between the two adherents, the method comprising:
a step of bonding the two adherents with the resin layer included in the film material for an interlayer according to claim 5 being interposed therebetween, to obtain a laminate; and
a step of heating and pressurizing the laminate under a condition of 30 to 150° C. and 0.3 to 1.5 MPa,
wherein at least one of the two adherents is a glass plate.

8. The method according to claim 7, wherein one of the two adherents is a glass plate and the other is a transparent plastic substrate.
